(19) United States
(12) Patent Application Publication
(10) Pub. No.: US 2019/0251539 A1
(43) Pub. Date: Aug. 15, 2019

(54) SYSTEM AND METHOD FOR CONDUCTING A TRANSANCTION

(71) Applicant: MASTERCARD ASIA/PACIFIC PTE. LTD., Singapore (SG)

(72) Inventors: Bensam Joyson, Singapore (SG); Xijing Wang, Singapore (SG); Donghao Huang, Singapore (SG); Teck Yong Tan, Singapore (SG); Hao Tang, Singapore (SG); Muhammad Azeem, Singapore (SG); Zunhua Wang, Singapore (SG); Anupam Sharma, Singapore (SG); Shiying Lian, Singapore (SG)

(21) Appl. No.: 16/256,706

(22) Filed: Jan. 24, 2019

(30) Foreign Application Priority Data
Feb. 9, 2018 (SG) 102018081145Q

(51) Int. Cl. G06Q 20/20; G06Q 20/40; G10L 15/26; B25J 11/00

(52) U.S. Cl. CPC G06Q 20/208; G06Q 20/204; B25J 11/0005; G06Q 20/40145; G10L 15/26; G06Q 20/206

(57) ABSTRACT

The present disclosure relates to methods and systems for conducting a transaction. The method comprises the steps of pairing a multi-sensory interactive point of sale with a mobile device at a first time. The step of pairing comprises the steps of receiving a transaction initiation instruction comprising identification data of a customer and an identifier associated with the multi-sensory interactive point of sale and transmitting authentication information to a mobile terminal registered to the customer based on the received identification data. The method further comprises the step of receiving a transaction selection. The method further comprises the step of processing a payment at a second time, wherein receiving the transaction selection occurs between the first time and the second time. The step of processing the payment comprises the steps of receiving a checkout request to the payment for the transaction, the checkout request comprising a sensory authentication input, and authorising the transaction based on a comparison between the received sensory authentication input and the authentication information transmitted to the registered mobile terminal.

### CROSS-REFERENCE TO RELATED APPLICATION

This application is a U.S. National Stage filing under 35 U.S.C. § 119, based on and claiming benefits of and priority to Singapore Patent Application No. 10201801145Q filed on Feb. 9, 2018. The entire disclosure of the above application is incorporated herein by reference.

### FIELD OF INVENTION

The present invention relates broadly, but not exclusively, to a system and method for conducting a transaction.

### BACKGROUND

Physical retail stores are facing fierce competition from e-commerce. In the midst of the competition, retail businesses have to apply innovative solutions to their businesses to stay competitive and be successful.

To attract shoppers, retail businesses invest substantial resources into in-store customer service. However, hiring in-store employees increases store operation overhead cost. To save such costs, retail businesses utilise technology. For example, stores use electronic devices to receive orders and payments from shoppers.

However, shoppers often find making payments using electronic devices troublesome. It is also a challenge to provide a payment system that is convenient and also secure and efficient. Currently, there are challenges to making payments using electronic devices as they can interfere with the shopping experience.

A need therefore exists to provide a system and method for conducting a transaction that address at least one of the problems above or to provide a useful alternative.

### SUMMARY

According to a first aspect of the present invention, there is provided a method for conducting a transaction, the method comprising the steps of:

pairing a multi-sensory interactive point of sale with a mobile device at a first time, wherein the step of pairing comprises the steps of:
receiving a transaction initiation instruction comprising identification data of a customer and an identifier associated with the multi-sensory interactive point of sale; and
transmitting authentication information to a mobile terminal registered to the customer based on the received identification data;

receiving a transaction selection; and

processing a payment at a second time, wherein receiving the transaction selection occurs between the first time and the second time, and processing the payment comprises the steps of:
receiving a checkout request to the payment for the transaction, the checkout request comprising a sensory authentication input; and
authorising the transaction based on a comparison between the received sensory authentication input and the authentication information transmitted to the registered mobile terminal.

The authentication information and the sensory authentication input may comprise one or more of: an alphanumeric data, a number, a gesture, an image, a facial expression and a spoken word.

The method may further comprise the steps of:

displaying, using a display screen of the multi-sensory interactive point of sale, a list of products available for purchase; and

receiving the transaction selection via the display screen, wherein the transaction selection comprises a selection of one or more products.

The step of receiving the checkout request may comprise receiving the authentication input provided to the display screen.

The step of receiving the checkout request may comprise the steps of:

receiving the spoken word using a microphone of the multi-sensory interactive point of sale; and

processing the spoken word into machine-readable data to determine the text of the spoken word.

The step of receiving the checkout request may comprise the steps of:

capturing, using an imaging device of the multi-sensory interactive point of sale, an image of the gesture presented to the multi-sensory interactive point of sale; and

processing the image into machine-readable data to determine the gesture.

The transaction initiation instruction may be received via an internet network.

The identifier associated with the multi-sensory interactive point of sale may comprise a bar code.

The authentication information may be transmitted via a telephone network.

The step of transmitting the authentication information may comprise the steps of:

encoding the authentication information into a bar code; and

transmitting the encoded bar code to the registered mobile terminal.

The step of receiving the checkout request may comprise scanning the encoded bar code using a bar code reader of the multi-sensory interactive point of sale.

The multi-sensory interactive point of sale may be a humanoid robot configured to engage in interactive activities.

According to a second aspect of the present invention, there is provided a computer system for conducting a transaction, comprising:

at least one processor; and

at least one memory module having computer program code stored thereon, the computer program code configured to, with the at least one processor, cause the computer system to:

pair a multi-sensory interactive point of sale with a mobile device at a first time, wherein the computer system is caused to:
receive a transaction initiation instruction comprising identification data of a customer and an identifier associated with the multi-sensory interactive point of sale; and
transmit authentication information to a mobile terminal registered to the customer based on the received identification data;

receive a transaction selection; and

process a payment at a second time, wherein the computer system receives the transaction selection between the first time and the second time, and wherein, at the second time, the computer system is caused to:
receive a checkout request to the payment for the transaction, the checkout request comprising a sensory authentication input; and
authorise the transaction based on a comparison between the received sensory authentication input and the authentication information transmitted to the registered mobile terminal.

The processor may be configured to compare the received sensory authentication input and the authentication information transmitted to the registered mobile terminal.

According to a third aspect of the present invention, there is provided a system for conducting a transaction, the system comprising:

a multi-sensory interactive point of sale configured to:
receive a checkout request to a payment for the transaction, the checkout request comprising a sensory authentication input; and
transmit the checkout request;

a database for storing data; and

a processor in communication with the multi-sensory interactive point of sale and the database,

wherein the processor is configured to:
pair the multi-sensory interactive point of sale with a mobile device at a first time, wherein the processor is configured to:
   receive a transaction initiation instruction comprising identification data of a customer and an identifier associated with the multi-sensory interactive point of sale; and
   transmit authentication information to a mobile terminal registered to the customer based on the received identification data, wherein details of the mobile terminal are stored in the database;
   receive a transaction selection; and
   process the payment at a second time, wherein the transaction selection is received between the first time and the second time, and wherein, at the second time, the processor is configured to:
      receive the checkout request to the payment for the transaction from the multi-sensory interactive point of sale; and
      authorise the transaction based on a comparison between the received sensory authentication input and the authentication information transmitted to the registered mobile terminal.

The multi-sensory interactive point of sale may comprise a display screen and may be further configured to receive the authentication input provided to the display screen.

The multi-sensory interactive point of sale may comprise a microphone and may be further configured to:

receive a spoken word using the microphone; and

process the spoken word into machine-readable data to determine the text of the spoken word.

The multi-sensory interactive point of sale may comprise an imaging device and may be further configured to:

capture, using the imaging device, an image of a gesture presented to the multi-sensory interactive point of sale; and

process the image into machine-readable data to determine the gesture.

The processor may be further configured to:

encode the authentication information into a bar code; and

transmit the encoded bar code to the registered mobile terminal.

The multi-sensory interactive point of sale may be further configured to scan the encoded bar code using a bar code reader of the multi-sensory interactive point of sale.

### BRIEF DESCRIPTION OF THE DRAWINGS

Embodiments of the invention are provided by way of example only, and will be better understood and readily apparent to one of ordinary skill in the art from the following written description and the drawings, in which:

FIG. 1 shows a diagram illustrating a system and method for conducting a transaction in accordance with an example embodiment.

FIG. 2 shows a flow chart illustrating a method for conducting a transaction in accordance with an example embodiment.

FIG. 3 shows a schematic diagram illustrating a computer suitable for implementing the system and method of the example embodiments.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “transmitting”, “authorising”, “displaying”, “processing”, “capturing”, “encoding”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

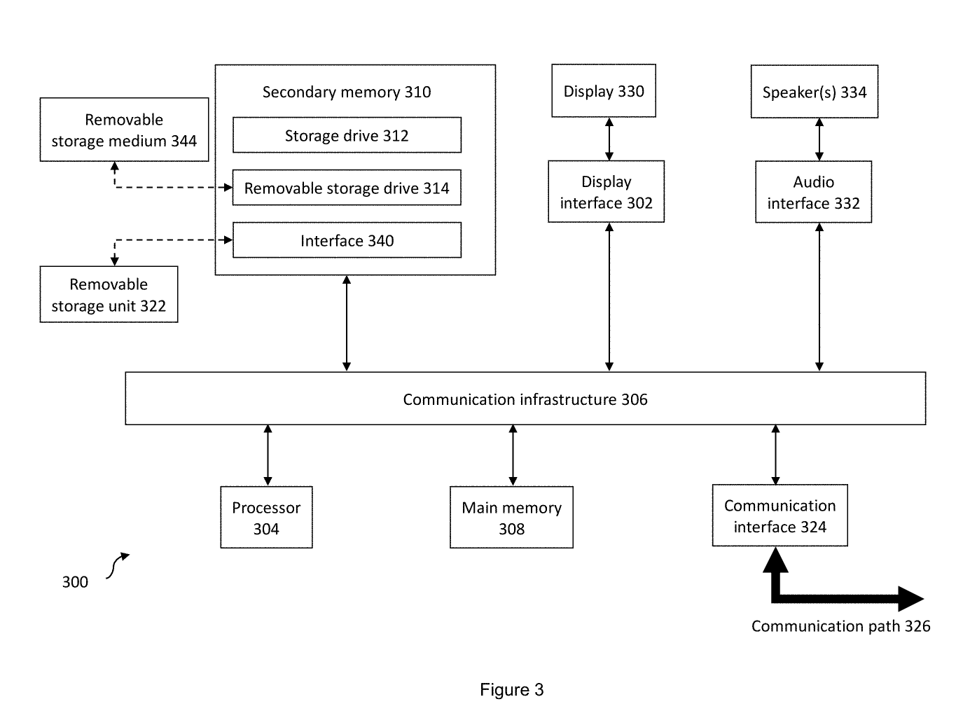

As used herein, the terms “server”, “terminal” and “database” refer to a single computing device or a plurality of interconnected computing devices which operate together to perform a particular function. That is, the “server”, “terminal” and “database” may be contained within a single hardware unit or be distributed among several or many different hardware units. An exemplary computing device which may be operated as a “server”, “terminal” and “database” is described below with reference to FIG. 3.

As used herein, the term “sensory authentication input” refers to any authentication information that can be sensed or detected by a multi-sensory interactive point of sale (i.e. one or more microphone, camera, touch screen, bar code reader, installed at a point of sale). The examples of the sensory authentication input include, but not limited to, alphanumeric data, a word, a number, an image, a spoken word, a gesture and an expression.

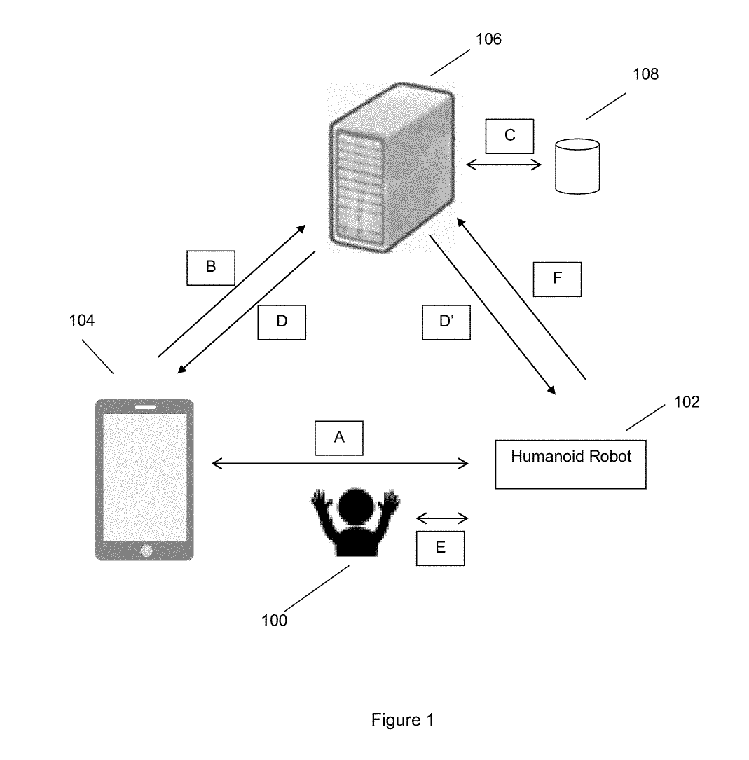

FIG. 1 shows a diagram illustrating a system and method for conducting a transaction in accordance with an example embodiment. FIG. 1 is explained with respect to a scenario in a physical store (hereinafter referred to as “store”), where a customer 100 purchases a product or service (product or service is hereinafter collectively referred to as “product”) in the store using a multi-sensory interactive point of sale (hereinafter referred to as “multi-sensory POS”) placed in the store. The store may include one or more multi-sensory POS, depending on the foot traffic in the store. The multi-sensory POS is represented in FIG. 1 as a humanoid robot 102.

The humanoid robot 102 is configured to engage in interactive activities with the customer 100. For example, the humanoid robot 102 has a humanoid form and is configured to perform activities such as shaking hands and making eye contact with customers 100. In an embodiment, the humanoid robot 102 includes a display screen (hereinafter referred to as “screen”) for displaying a list of products available for purchase in the store; and has touch screen capability which allows the customer 100 to make a transaction selection, such as a selection of one or more products listed on the display screen.

To initiate the purchasing process, the customer 100 activates a merchant mobile application (hereinafter referred to as a “merchant app”) installed in an electronic device, represented as a mobile device 104 in FIG. 1. Typically, the merchant app is developed by a merchant for customers 100 to perform in-app purchases or in-app payments. In an embodiment, the merchant app is integrated with or makes an application call to a digital wallet thus allowing customers 100 to make in-app payments using the digital wallet for items bought in the store using the humanoid robot 102. Customers 100 usually have to provide identification data to access the merchant app and/or the digital wallet.

It should be noted that, instead of using a digital wallet, other payment methods can be chosen to make in-app payments in the merchant app. The payment methods may involve using payment instruments such as in-app credit, credit/debit card, and third-party online payment platforms (e.g. PayPal and Alipay). The details of these payment instruments can be saved in the merchant app and selected for making the in-app payments.

At step A, the customer 100 pairs the mobile device 104 with the humanoid robot 102 at a first time. The customer 100 may be prompted to pair the mobile device 104 by the humanoid robot 102, or pairing between the mobile device 104 and the humanoid robot 102 may be initiated automatically. In an embodiment, the humanoid robot 102 is assigned a name and the screen displays a request to say the name of the humanoid robot 102 to start interacting with the humanoid robot 102. For example, the name of the humanoid robot 102 is “Robot” and the customer 100 says “Robot” or “Hi Robot” to the humanoid robot 102 in order to initiate the transaction. It will be appreciated that customers 100 may also initiate the interaction with the humanoid robot 102 in other ways. For example, the customer 100 may simply touch the screen or wave to the humanoid robot 102 to initiate the interaction with the humanoid robot 102.

Next, a bar code is displayed on the screen of the humanoid robot 102. The bar code represents a unique identifier (hereinafter referred to as “identifier”) of the humanoid robot 102. In an embodiment, the merchant app is configured to send a signal to a camera of the mobile device 104 to capture the bar code and extract data from the captured bar code. The customer 100 operates the merchant app to access the camera of the mobile device 104 and scans the bar code displayed on the screen using the bar code reading function. In another embodiment, the merchant app is given access to a photo gallery of the mobile device 104 to obtain a picture of the bar code saved in the photo gallery of the mobile device 104. The merchant app is configured to extract the identifier from the scanned bar code.

At step B, the customer 100 sends a transaction initiation instruction (hereinafter referred to as “instruction”) to a merchant server 106 using the mobile device 104. This instruction serves to notify the merchant server 106 that the mobile device 104 is seeking to pair with the humanoid robot 102, where the pairing marks the initiation of a sequence to make a purchase with the humanoid robot 102. In an embodiment, the instruction is sent via an internet network to the merchant server 106. The instruction includes the identifier and identification data of the customer 100. The merchant server 106 receives the transaction initiation instruction, including the identification data of the customer and the identifier associated with the multi-sensory interactive POS from the mobile device 104. The identification data is registered to a customer account signed up with the merchant app and is used by the customer 100 to log into their customer account using the merchant app. In an embodiment, the identification data includes an access code (e.g. customer account name, customer identification number, customer phone number) and an authentication data (e.g. biometric data, password). For example, the customer logs into the customer account using an account name and a password. It should be noted that the identification data can also be identification data registered to a customer account signed up with a payment instrument, e.g. a digital wallet, an online payment platform, credit/debit card, which is chosen to make the in-app payment. In an embodiment, upon successful scanning of the bar code, the identifier and the identification data are automatically transmitted from the merchant app to the merchant server 106 via the internet network.

In an embodiment, the merchant server 106 also receives details of the digital wallet from the mobile device 104. For example, the mobile device 104 would transmit a payment token to the merchant server 106. The payment token is used to obtain other checkout data used for completing the transaction. It should be noted that the types of payment instrument details received by the merchant server 106 varies according to the payment method chosen. For example, if a credit card is chosen to make the payment for the transaction, the mobile device 104 would transmit the credit card details, e.g. the credit card number and card verification value (CVV), to the merchant server 106.

The bar code includes an identifier of the humanoid robot 102. Thus, by receiving the bar code from the mobile device 104, the merchant server would be able to pair the humanoid robot 102 and the mobile device 104. In other words, if the authentication process of the customer's identity is successful during checkout, an upcoming purchase made using the humanoid robot 102 would be paid using the digital wallet integrated with the merchant app installed in the mobile device 104.

Upon receiving the transaction initiation instruction from the mobile device 104, the merchant server 106 gains access to the customer details registered under the customer account, as illustrated at step C. The customer details are stored in a customer database 108 and include the contact details of a mobile terminal registered under the customer account. Authentication information is generated specifically for use in the upcoming transaction and is transmitted to the registered mobile terminal based on the contact details obtained from the customer database 108. At step D, the merchant server 106 transmits the authentication information to the mobile terminal registered to the customer 100 based on the received identification data. For example, if the mobile device 104 is the registered mobile terminal, the authentication information would be transmitted to the mobile device 104, as illustrated in FIG. 1. In an embodiment, the authentication information is transmitted via a telephone network to the registered mobile terminal.

The authentication information is used for customer authentication at the humanoid robot 106 during checkout, as it provides a means to verify that the customer 100 is indeed who they claim to be. In particular, the humanoid robot 102 will prompt the customer 100 to provide a sensory authentication input (hereinafter referred to as “authentication input”) and the transaction will only be authorised if the authentication input is accurate. The authentication input is accurate if it matches with the authentication information transmitted to the mobile device 104. Otherwise, the transaction will not be authorised. One approach of performing this matching is done at step F, which is described below. In an embodiment, the authentication information can be an image of an item (e.g. an image of an umbrella).

It should be noted that, instead of a telephone network, the authentication information can be transmitted to the registered mobile terminal via an internet network, e.g. to a mobile messaging application. It should also be noted that the authentication information may not be transmitted to the mobile device 104 that initiate the pairing with the humanoid robot 102 if the mobile device 104 is not the mobile terminal registered with the customer account.

Upon receiving the authentication information, the customer 100 makes transaction selection using the screen of the humanoid robot 102. The transaction selection includes one or more products that the customer 100 wishes to purchase from the store. Upon completing the transaction selection, the customer 100 sends confirmation of the transaction selection using the screen of the humanoid robot 102. The merchant server 106 receives the transaction selection from the humanoid robot 102.

Upon receiving the transaction selection, the payment is processed at a second time. As explained above, the pairing process between the humanoid robot 102 and the mobile device 104 occurs at the first time. After the pairing process, the customer 100 can put away his mobile device 104 and proceed to make selection of the products that they wish to purchase from the store. Upon the completion of the transaction selection, the customer 100 may proceed with the payment process without accessing his mobile device 104. In other words, at the time interval between the first time and the second time, the customer 100 makes the transaction selection and the transaction selection made by the customer 100 is received by the merchant server 106. It should be noted that the payment process at the second time includes an authentication process of the customer's identity as illustrated at step E. Specifically, at step E, the screen prompts the customer 100 to provide the authentication input. The authentication input is sensed by the humanoid robot 102. In one implementation where the authentication input is an image, the screen displays multiple images, e.g. that of a pair of shoes, a shirt, a building, a cup, a fruit and an umbrella, for selection by customers 100. With reference to step C above, the image transmitted to the registered mobile terminal is the image of an umbrella. The authentication process will be successful if the customer 100 selects, among the multiple images displayed on the screen, the image of an umbrella displayed on the screen.

It should be noted that in addition to an image, the authentication information and authentication input can be in various forms, such as alphanumeric data, a word, a number, a spoken word, a gesture and an expression. For example, the authentication information transmitted to the registered mobile terminal is an image that includes a gesture or a facial expression. The customer 100 has to make the gesture or facial expression to the humanoid robot 102 when providing the authentication input. The word may be sent to the registered mobile terminal in text form and the customer 100 has to provide the authentication input to the humanoid robot 102 by saying the word to the humanoid robot 102. The authentication information, such as alphanumeric data, word and number, may also be encoded into a bar code for transmission to the registered mobile terminal.

In an embodiment, the humanoid robot 102 includes a microphone. The customer 100 can provide the authentication input to the humanoid robot 102 by speaking to the microphone. The humanoid robot 102 uses text recognition software to process the spoken word into machine-readable data to determine the text of the spoken word. In yet another embodiment, the humanoid robot 102 has a camera. The customer 100 can provide the authentication input by making a gesture to the humanoid robot 102 and the camera can capture the gesture presented to the humanoid robot 102 as an image or a video. The humanoid robot 102 can process the image or the video into machine-readable data to determine the gesture. In a further embodiment, the humanoid robot 102 includes a bar code reader. If the authentication information has been encoded into a bar code and transmitted to the registered mobile terminal, the customer 100 can provide the authentication input by scanning the bar code using the bar code reader. The humanoid robot 102 can process the bar code and determine the authentication input.

The authentication process at step E can be adapted into a form of game. For example, in a store that sells yoga accessories, the authentication information provided to the registered mobile terminal may be an image of a yoga pose and the customer 100 is required to provide authentication input to the humanoid robot 102 by striking the yoga pose. Thus, customers 100 can make payments in a secure way and at the same time, engage in a fun game with the humanoid robot 102.

At step F, the merchant server 106 receives a checkout request to the payment for the transaction for a purchase of the products in the store. The checkout request includes the sensory authentication input provided by the customer 100 to the humanoid robot 102. The checkout request may also include the total transaction amount and product details, such as price of the product and the product description. Next, the merchant server 102 authorise the transaction based on a comparison between the sensory authentication input received from the humanoid robot 102 at step E and the authentication information transmitted to the registered mobile terminal at step C. If the authentication input received from the humanoid robot 102 matches the authentication information provided to the registered mobile terminal, the customer authentication will be successful and the transaction will be authorised. Otherwise, the transaction will be rejected.

In an example, the word “coffee” is sent to the registered mobile terminal at step C during the pairing process at a first time. The customer then proceeds with making transaction selections using the screen of the humanoid robot 102. Upon completion of the transaction selections, the customer 100 proceeds with making payment at a second time by providing the authentication input. In this example, the customer may provide the authentication input at step E by saying the word “coffee” to the humanoid robot 102. The spoken word “coffee” is processed by the humanoid robot 102 and the text of the spoken word is determined to be “coffee”. The data related to the text “coffee” and the total transaction amount is transmitted to the merchant server 106. Upon determining that the authentication input matches with the authentication information transmitted to the registered mobile terminal, the merchant server 106 authorises the payment transaction by settling the total transaction amount using the digital wallet selected by the customer 100 to make in-app payments.

It should be noted that the merchant server 106 can also transmit the authentication information to the humanoid robot 102 upon pairing of the humanoid robot 102 and mobile device 104 (as described in steps A and B), as illustrated at step D′, such that comparison between the sensory authentication input provided by the customer 100 to the humanoid robot 102 and the authentication information transmitted to the mobile device 104 can be made by the humanoid robot 102. The humanoid robot 102 subsequently transmits an outcome of the comparison, i.e. whether there is a match or mismatch, to the merchant server 106. The merchant server 106 then authorises the transaction based on the comparison made by the humanoid robot 102, whereby the transaction is approved if the outcome of the comparison is a match.

Embodiments of the present invention provide a system and method that facilitate customer authentication for transactions made in a store. The payment instrument details are saved in a mobile device and transmitted to the merchant server prior to checking out at the store, thus allowing hands-free payment and cashless payment experience when customers 100 are checking out at the store. In other words, after pairing the humanoid robot 102 and the mobile device 104, the customer 100 does not need to further interact with the mobile device 104 in order to proceed with making payment for the transaction.

If the person interacting with the humanoid robot does not have the mobile terminal registered under the customer account, they will not be able to provide an accurate authentication input to the humanoid robot during checkout and thus, will not be able to make payment for a purchase made with the humanoid robot. For example, a person may obtain the identification data of a customer through identity theft. The identity thief may be able to log into the customer account in the merchant app and pair the humanoid robot with a mobile device used by them. However, the thief will not receive the authentication information from the merchant server upon the pairing since the mobile device used by them is not the mobile terminal registered to the customer account. Consequently, the thief will not be able to provide an accurate authentication input to the humanoid robot and thus, will not be able to complete the authentication process. In other words, embodiments of the present invention may advantageously include an authentication process that prevents a person from making fraudulent payments, even if the person has the identification data of the rightful customer.

Since no in-store employee is required to facilitate the transaction, the system and method are also useful in providing in-store customer service without adding overhead cost. The systems and method are also suitable for conducting a transaction at a self-service point-of-sale terminal (hereinafter referred to as “POS”) that does not need to be manned. For example, the POS can be installed in a vehicle to provide an unmanned vehicle-sharing service. The POS may be placed inside the vehicle, e.g. a rental car, and the customer is required to complete the customer authentication process using the POS before completing the transaction and starting the engine of the rental car. As an example of the customer authentication process, the word “rental” is sent to the mobile terminal registered with the customer account and the customer is requested to say the word “rental” to the POS to complete the customer authentication process. Evidently, the systems and a method provide secure and efficient ways to make payments and yet, the customer experience is not compromised.

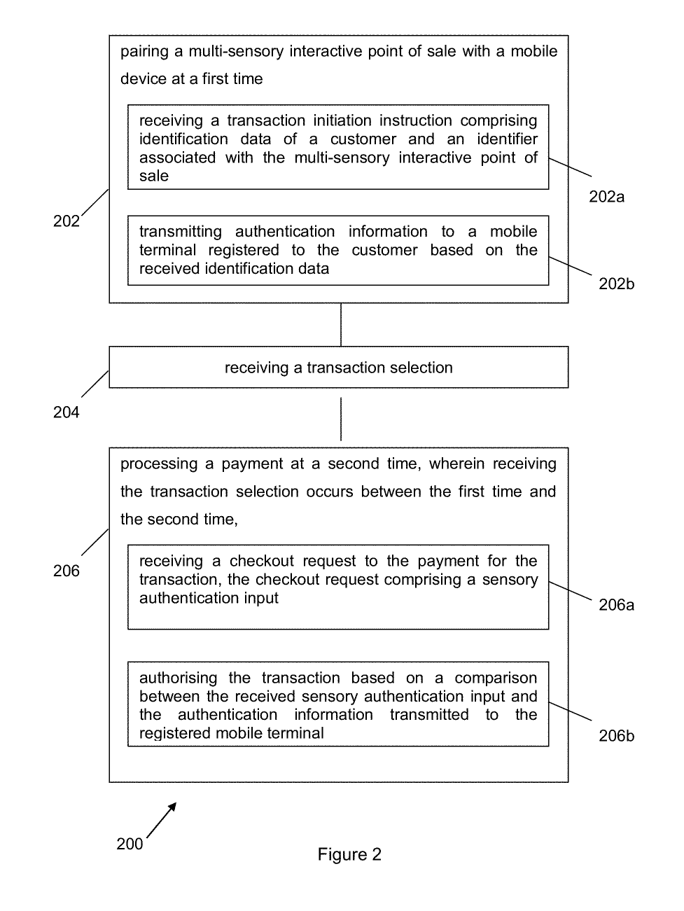

FIG. 2 shows a flow chart 200 illustrating a method for conducting a transaction in accordance with an example embodiment. At step 202, a multi-sensory interactive point of sale is paired with a mobile device at a first time. The step of pairing comprises steps 202a and 202b. At step 202a, a transaction initiation instruction comprising identification data of a customer and an identifier associated with the multi-sensory interactive point of sale is received. At step 202b, authentication information is transmitted to a mobile terminal registered to the customer based on the received identification data. At step 204, a transaction selection is received. At step 206, a payment is processed at a second time, wherein receiving the transaction selection occurs between the first time and the second time. The step of processing the payment comprises steps 206a and 206b. At step 206a, a checkout request to the payment for the transaction is received. The checkout request comprising a sensory authentication input. At step 206b, the transaction is authorised based on a comparison between the received sensory authentication input and the authentication information transmitted to the registered mobile terminal.

One advantage of embodiments of the present invention is that the authentication information is transmitted to the customer's mobile device (step C of FIG. 1) during the pairing process at first time, and after the pairing process, the customer 100 can turn off or put away his mobile device and proceed with making transaction selections. When the customer 100 has completed his transaction selections, he may proceed to the payment process of the transaction at a second time without needing to again refer to or access his mobile device. In other words, the transaction can be conducted with only a single interaction between the customer 100 and the mobile device 104. In this way, the transaction process is made more convenient as repeated use of the mobile device is not required.

In another embodiment, the authentication information may be valid for multiple transactions and the customer 100 may initiate a second transaction and make payment of the second transaction using the authentication information. For example, a customer 100 may be driving and processing transactions from his vehicle over a connected, in-vehicle robot. In this situation, the customer 100 could initiate and complete multiple transactions after only pairing his mobile device with the in-vehicle robot once.

FIG. 3 depicts an exemplary computing device 300, hereinafter interchangeably referred to as a computer system 300, where one or more such computing devices 300 may be used in conducting a transaction (e.g. to realise the humanoid robot 102 and the merchant server 106). The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The software routines, or computer programs, may be stored in memory (e.g. main memory 308) and be executable by the processor 304 to cause the computer system 300 to: (A) pair a multi-sensory interactive point of sale with a mobile device at a first time; (A1) receive a transaction initiation instruction comprising identification data of a customer and an identifier associated with the multi-sensory interactive point of sale; (A2) transmit authentication information to a mobile terminal registered to the customer based on the received identification data; (B) receive a transaction selection; (C) process a payment at a section time, wherein receiving the transaction selection occurs between the first time and the second time; (C1) receive a checkout request to the payment for the transaction, the checkout request comprising a sensory authentication input; and (C2) authorise the transaction based on a comparison between the received sensory authentication input and the authentication information transmitted to the registered mobile terminal. The software routines or computer programs may also comprise steps executable by the processor to cause the computer system 300 to perform the various other analytical steps (e.g. comparing the received sensory authentication input and the authentication information transmitted to the registered mobile terminal; displaying a list of products available for purchase; receiving a transaction selection, wherein the transaction selection comprises a selection of one or more products; receiving a spoken word using a microphone of the multi-sensory POS; processing the spoken word into machine-readable data to determine the text of the spoken word).

The computing device 300 further includes a main memory 308, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage unit 318 in a well-known manner. The removable storage unit 318 may include a floppy disk, magnetic tape, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, and other removable storage units 322 and interfaces 320 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical, or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. Computer readable storage media refers to any non-transitory tangible storage medium that provides recorded instructions and/or data to the computing device 300 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer program product may be stored in the main memory 308 in the form of instructions executable by the processor to cause the computer system 300 to: (A) pair a multi-sensory interactive point of sale with a mobile device at a first time; (A1) receive a transaction initiation instruction comprising identification data of a customer and an identifier associated with the multi-sensory interactive point of sale; (A2) transmit authentication information to a mobile terminal registered to the customer based on the received identification data; (B) receive a transaction selection; (C) process a payment at a section time, wherein receiving the transaction selection occurs between the first time and the second time; (C1) receive a checkout request to the payment for the transaction, the checkout request comprising a sensory authentication input; and (C2) authorise the transaction based on a comparison between the received sensory authentication input and the authentication information transmitted to the registered mobile terminal. The computer program product may also comprise steps which, when executed by the processor, cause the computer system 300 to perform the various other analytical steps (e.g. comparing the received sensory authentication input and the authentication information transmitted to the registered mobile terminal; displaying a list of products available for purchase; receiving a transaction selection, wherein the transaction selection comprises a selection of one or more products; receiving a spoken word using a microphone of the multi-sensory POS; processing the spoken word into machine-readable data to determine the text of the spoken word).

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the hard disk drive 312, or the interface 320. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

It will be appreciated by a person skilled in the art that numerous variations and/or modifications may be made to the present invention as shown in the specific embodiments without departing from the spirit or scope of the invention as broadly described. For example, while embodiment of the present invention are illustrated and described in conjunctions with a humanoid robot, the disclosed embodiments may be used with any other type of robot including robots taking non-humanoid forms, digital assistants (e.g. Echo and Siri), chatbots, and any similar interactive interfaces for conducting transactions. The present embodiments are, therefore, to be considered in all respects to be illustrative and not restrictive.

1. A method for conducting a transaction, the method comprising the steps of:
pairing a multi-sensory interactive point of sale with a mobile device at a first time, wherein the step of pairing comprises the steps of:
receiving a transaction initiation instruction comprising identification data of a customer and an identifier associated with the multi-sensory interactive point of sale; and
transmitting authentication information to a mobile terminal registered to the customer based on the received identification data;
receiving a transaction selection; and
processing a payment at a second time, wherein receiving the transaction selection occurs between the first time and the second time, and processing the payment comprises the steps of:
receiving a checkout request to the payment for the transaction, the checkout request comprising a sensory authentication input; and
authorising the transaction based on a comparison between the received sensory authentication input and the authentication information transmitted to the registered mobile terminal.

2. The method as claimed in claim 1, wherein the authentication information and the sensory authentication input comprise one or more of: an alphanumeric data, a number, a gesture, an image, a facial expression and a spoken word.

3. The method as claimed in claim 1, further comprising the steps of:
displaying, using a display screen of the multi-sensory interactive point of sale, a list of products available for purchase; and
receiving the transaction selection via the display screen, wherein the transaction selection comprises a selection of one or more products.

4. The method as claimed in claim 3, wherein receiving the checkout request comprises receiving the authentication input provided to the display screen.

5. The method as claimed in claim 2, wherein receiving the checkout request comprises the steps of:
receiving the spoken word using a microphone of the multi-sensory interactive point of sale; and
processing the spoken word into machine-readable data to determine the text of the spoken word.

6. The method as claimed in claim 2, wherein receiving the checkout request comprises the steps of:
capturing, using an imaging device of the multi-sensory interactive point of sale, an image of the gesture presented to the multi-sensory interactive point of sale; and
processing the image into machine-readable data to determine the gesture.

7. The method as claimed in claim 1, wherein the transaction initiation instruction is received via an internet network.

8. The method as claimed in claim 1, wherein the identifier associated with the multi-sensory interactive point of sale comprises a bar code.

9. The method as claimed in claim 1, wherein the authentication information is transmitted via a telephone network.

10. The method as claimed in claim 1, wherein transmitting the authentication information comprises the steps of:
encoding the authentication information into a bar code; and
transmitting the encoded bar code to the registered mobile terminal.

11. The method as claimed in claim 10, wherein receiving the checkout request comprises scanning the encoded bar code using a bar code reader of the multi-sensory interactive point of sale.

12. The method as claimed in claim 1, wherein the multi-sensory interactive point of sale is a humanoid robot configured to engage in interactive activities.

13. A computer system for conducting a transaction, comprising:
at least one processor; and
at least one memory module having computer program code stored thereon, the computer program code configured to, with the at least one processor, cause the computer system to:
pair a multi-sensory interactive point of sale with a mobile device at a first time, wherein the computer system is caused to:
receive a transaction initiation instruction comprising identification data of a customer and an identifier associated with the multi-sensory interactive point of sale; and
transmit authentication information to a mobile terminal registered to the customer based on the received identification data;
receive a transaction selection; and
process a payment at a second time, wherein the computer system receives the transaction selection between the first time and the second time, and wherein, at the second time, the computer system is caused to:
receive a checkout request to the payment for the transaction, the checkout request comprising a sensory authentication input; and
authorise the transaction based on a comparison between the received sensory authentication input and the authentication information transmitted to the registered mobile terminal.

14. The computer system as claimed in claim 13, wherein the processor is configured to compare the received sensory authentication input and the authentication information transmitted to the registered mobile terminal.

15. A system for conducting a transaction, the system comprising:
a multi-sensory interactive point of sale configured to:
receive a checkout request to a payment for the transaction, the checkout request comprising a sensory authentication input; and
transmit the checkout request;
a database for storing data; and
a processor in communication with the multi-sensory interactive point of sale and the database,
wherein the processor is configured to:
pair the multi-sensory interactive point of sale with a mobile device at a first time, wherein the processor is configured to:
receive a transaction initiation instruction comprising identification data of a customer and an identifier associated with the multi-sensory interactive point of sale; and
transmit authentication information to a mobile terminal registered to the customer based on the received identification data, wherein details of the mobile terminal are stored in the database;
receive a transaction selection; and
process the payment at a second time, wherein the transaction selection is received between the first time and the second time, and wherein, at the second time, the processor is configured to:
receive the checkout request to the payment for the transaction from the multi-sensory interactive point of sale; and
authorise the transaction based on a comparison between the received sensory authentication input and the authentication information transmitted to the registered mobile terminal.

16. The system as claimed in claim 15, wherein the multi-sensory interactive point of sale comprises a display screen and is further configured to receive the authentication input provided to the display screen.

17. The system as claimed in claim 15, wherein the multi-sensory interactive point of sale comprises a microphone and is further configured to:
receive a spoken word using the microphone; and
process the spoken word into machine-readable data to determine the text of the spoken word.

18. The system as claimed in claim 15, wherein the multi-sensory interactive point of sale comprises an imaging device and is further configured to:
capture, using the imaging device, an image of a gesture presented to the multi-sensory interactive point of sale; and
process the image into machine-readable data to determine the gesture.

19. The system as claimed in claim 15, wherein the processor is further configured to:
encode the authentication information into a bar code; and
transmit the encoded bar code to the registered mobile terminal.

20. The system as claimed in claim 19, wherein the multi-sensory interactive point of sale is further configured to scan the encoded bar code using a bar code reader of the multi-sensory interactive point of sale.
